(19) United States
(12) Patent Application Publication
(10) Pub. No.: US 2002/0147749 A1
(43) Pub. Date: Oct. 10, 2002

(54) Mobile presentation system

(76) Inventors: C. Enrique Ortiz, Round Rock, TX (US); John F. Wood, Austin, TX (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 09/681,840

(22) Filed: Jun. 14, 2001

Related U.S. Application Data
(60) Provisional application No. 60/281,970, filed on Apr. 6, 2001.
(60) Provisional application No. 60/281,968, filed on Apr. 6, 2001.

(51) Int. Cl. H04Q 7/20; G06F 15/00; G06F 17/00; G06F 17/21; G06F 17/24

(52) U.S. Cl. 707/523; 707/526; 707/513; 455/422

(57) ABSTRACT

A method can be used to generate information for a user. The method can determine the attribute(s) of the user's device and determine the appropriate grammar for the device. The method may access a grammar cache to determine if the appropriate grammar is in the grammar cache. If it is, the grammar can be sent to a servlet engine to generate the information in the appropriate presentation form for the user. If not, presentation information, business logic, a device profile, and a transformation rule can be used to generate the grammar that is sent to the servlet engine. An information handling system can be used to implement the method and send information to the user in a form that is more user friendly and compatible with the presentation component of the user's device.

### CROSS REFERENCE TO RELATED APPLICATIONS

This application claims priority under 35 U.S.C. §119(e) to U.S. patent application Ser. No. 60/AAA,BBB entitled “Mobile Presentation System” by Ortiz et al. filed Apr. 6, 2001, and U.S. patent application Ser. No. 60/XXX,YYY entitled “Application Description Markup Language” by Ortiz et al. filed Apr. 6, 2001. This is also related to U.S. patent application Ser. No. (Attorney Docket AGEA1140-1) entitled “Mobile Presentation System Using Application Description Markup Language” by Ortiz et al. filed of even date. All applications listed in this paragraph and are assigned to the current assignee hereof and are incorporated herein by reference.

### BACKGROUND OF INVENTION

1. Field of the Invention

This invention relates in general to methods and information handling systems, and more particularly, to methods of generating information for a user and information handling systems for carrying out those methods.

2. Description of the Related Art

Characteristics of mobile devices vary widely. Some mobile devices may support only specific type(s) of markup languages. Other mobile devices have limitations due to screen size or other hardware, software, or firmware configurations.

Information from websites or other network sources may do a poor job of presenting the information. Typically, a web page is generated for a specific markup language or for a specific type of presentation device. The ability to present information on various types of mobile devices has meant that the user of a particular device may have to deal with annoying organizations of information that is difficult to read or through which to navigate. As an attempt to fix this problem, a website operator may generate many different pages of the same information to accommodate the different combinations of markup languages and device limitations (e.g., screens for the devices). Generating many different pages in different formats to accommodate the different markup language-device combinations can be very costly.

A need exists to create more “adaptable” information that can be transformed into a form that is more pleasurable to a user. Also, a need exists to provide such information without requiring a large number of different pages with the same information to support the wide variety of markup languages and device characteristics seen with mobile communicating devices.

### SUMMARY OF INVENTION

A system has been devised to generate a more user-friendly interface that can be used when sending the same information to a plethora of different mobile communicating devices. The system can use integration classes to separate presentation/user interface information from business logic. The system also can use a device profile of the connecting device and a transformation rule to get the information into the appropriate markup language for the connecting device. The system allows the ability to generate code for a web page as little as one time without having to rea web page for each combination of markup language and device. The system can be easily updated for new markup languages and devices that may be made available in the future.

In one set of embodiments, a method of generating information can comprise receiving a request for the information from a device. The method also can comprise accessing presentation information and business logic corresponding to the request. The method can further comprise determining an attribute of the device and accessing a transformation rule that can be used to transform the presentation information and the business logic for a markup language to a different markup language compatible with the user's device. The method can comprise generating a grammar consistent with the presentation information, the business logic, the attribute of the device, and the transformation rule. The method can also comprise using the grammar to generate the information.

In another set of embodiments, a method of generating information can comprise receiving a request for the information from a device. The method can also comprise determining that the information should be in a form using a specific grammar. The method can further comprise determining that the specific grammar resides in memory. The specific grammar may be consistent with presentation information, business logic, an attribute of the device, and a transformation rule. The presentation information and the business logic may correspond to the request. The transformation rule can be used to transform the presentation information and business logic in a markup language to a different markup language compatible with the device. The method can also comprise using the grammar in generating the information.

In still another set of embodiments, an information handling system can be used for generating an information in response to a request from a device. The system can comprise a document profile component, a device profile component, a transformation rule component, and a presentation component. The document profile component can provide a presentation information and a business logic corresponding to the request. The device profile component can provide an attribute of a device. The transformation rule component can provide a transformation rule that can be used to transform the presentation information and the business logic in a markup language to a different markup language compatible with the device. The presentation component can generate a grammar consistent with the presentation information and the business logic, the attribute of the device, and the transformation rule.

The foregoing general description and the following detailed description are exemplary and explanatory only are not restrictive of the invention, as claimed.

### BRIEF DESCRIPTION OF DRAWINGS

The present invention is illustrated by way of example and not limitation in the accompanying figures, in which:

FIG. 1 includes an illustration of a user-server system for a variety of mobile communicating devices;

FIG. 2 includes an illustration of an alternative hardware configuration for a server computer;

FIG. 3 includes an illustration of a data processing system readable medium including software code;

FIG. 4 includes an illustration of software components that can be used in assembling information for the user;

FIGS. 5 and 6 include a process flow diagram illustrating generation of a grammar for a device-markup language combination; and

FIGS. 7 and 8 include exemplary displays generated using ADML code.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Reference is now made in detail to the exemplary embodiments of the invention, examples of which are illustrated in the accompanying drawings. Wherever possible, the same reference numbers will be used throughout the drawings to refer to the same or like parts (elements).

In accordance with a set of embodiments of the present invention, an information handling system or a method can be used to generate information for a device. The method can determine the attribute(s) of the device and determine the appropriate grammar for the device. The method may access a grammar cache to determine if the appropriate grammar is in the grammar cache. If it is, the grammar can be sent to a servlet engine to generate the information in the appropriate presentation form for the device and markup language used with that device. If not, presentation information, business logic, a device profile, and a transformation rule can be used to generate the grammar that is sent to the servlet engine. The system can be used to implement the method and send information to the user in a form that is more user friendly and compatible with a presentation component of the user's device.

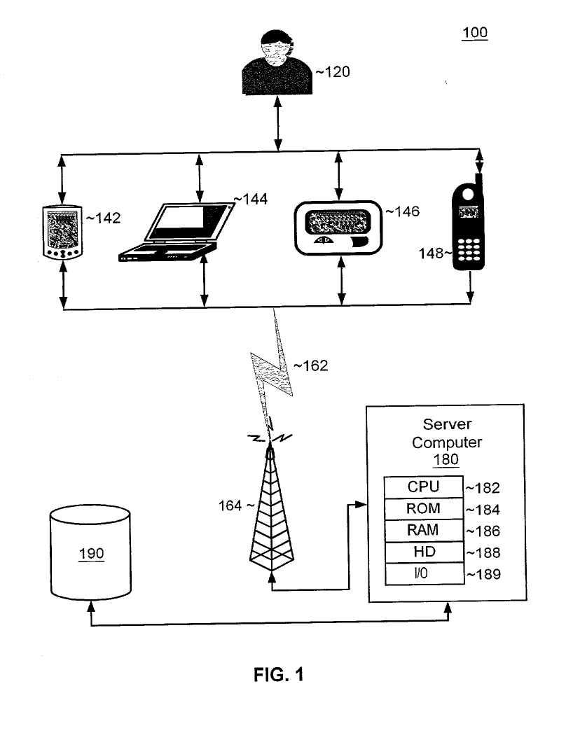

FIG. 1 includes an illustration of a user-server configuration for an information handling system 100 that can be used for a variety of mobile communicating devices. The user 1 20 may use a personal digital assistant (PDA) 142, a laptop computer 144, a pager 146, a mobile phone 148 (e.g., cellular phone), or the like. Unlike a desktop computer, each of the items shown in FIG. 1 is readily portable and typically has a mass no greater than approximately 4.5 kilograms. In one implementation, any or all of the mobile devices can be bicoupled to the server computer 180 via a wireless communication medium 162 and an antenna 164. The server computer 180 may include a central processing unit (“CPU”) 182, a read-only memory (ROM) 184, a random-access memory (“RAM”) 186, a hard drive (“HD”) or storage memory 188, and input/output device(s) (“I/O”) 189. The I/O devices 189 can include a keyboard, monitor, printer, electronic pointing device (e.g., mouse, trackball, etc.), or the like. The server computer 180 may be bi-directionally coupled to a database 190 that may include many different tables or files. The database 190 may reside external to the server computer 180 as shown in FIG. 1 or may reside on HD 188 if the database is not too large.

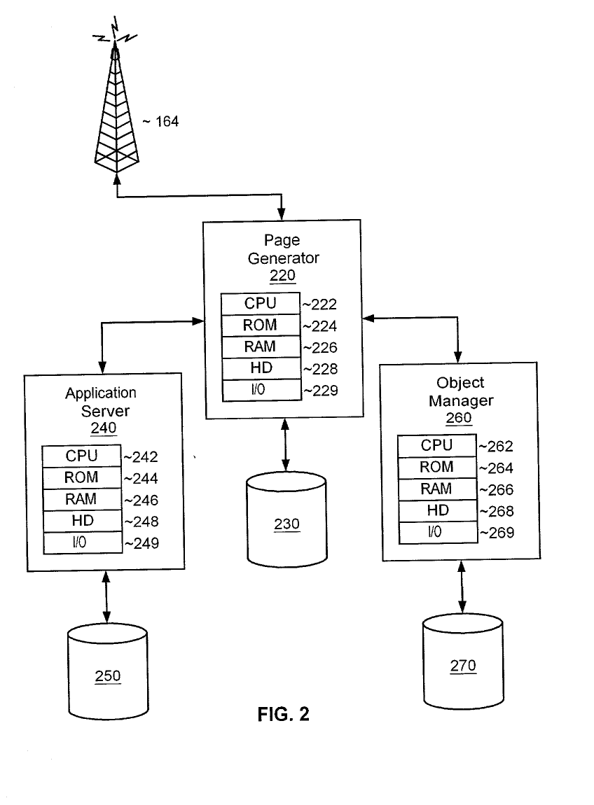

In an alternate embodiment, the server computer 180 may be replaced by a combination of computers including a page generator 220, an application server 240, and an object manager 260 as shown in FIG. 2. The page generator 220 can be bi-directionally coupled to the antenna 164, the application server 240, the object manager 260, and a database 230. The application server can be bi-directionally coupled to a database 250, and the object manager 260 can be bi-directionally coupled to a database 270. The application server 240 can be considered the “back-end logic” data processing system because it may have access to tables and files within database 250 and be configured to perform computations quickly. Each of the page generator 220, application server 240, and the object manager 260 may include a CPU (222, 242, 262), ROM (224, 244, 264), RAM (226, 246, 266), HD (228, 248, 268), and I/O (229, 249, 269) is similar to its corresponding feature in the server computer 180.

Each of the devices 41, 144, 146, and 146, the server computer 180, the page generator 220, application server 240, and the object manager 260 are examples of data processing systems. ROM (184, 224, 244, 264), RAM (186, 226, 246, 266), HD (188, 228, 248, 268), and the databases 190, 230, 250, and 270 include media that can be read by the CPUs. Therefore, each of these types of memories includes a data processing system readable medium. These memories may be internal or external to the devices 142, 144, 146, 148 the server computer 180, the page generator 220, application server 240, and the object manager 260.

Clearly, many other configurations are possible. The configurations shown in FIG. 1 or 2 or described herein is to be viewed as exemplary and not limiting.

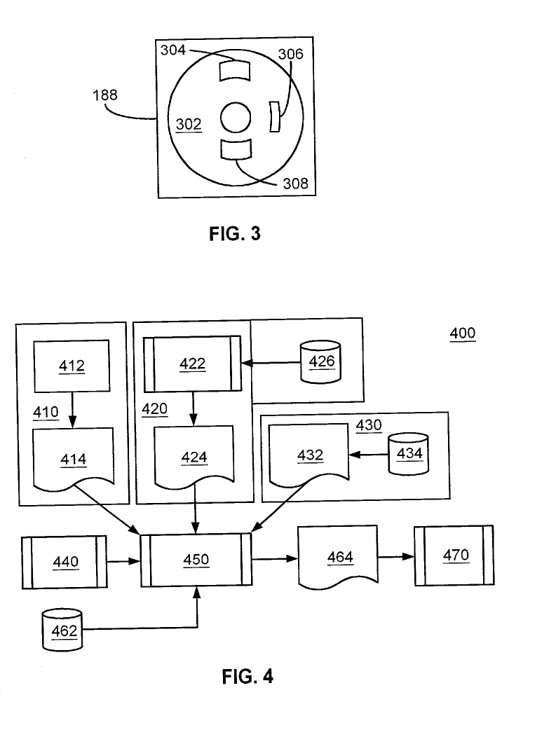

The methods described herein may be implemented in suitable software code that may reside within ROM (184, 224, 244, 264), RAM (186, 226, 246, 266), HD (188, 228, 248, 268), or database 190, 230, 250, and 270. FIG. 3 illustrates a combination of software code elements 304, 306, and 308 that are embodied within a data processing system readable medium 302, on the hard drive 188. In addition to the types of memories described above, the instructions in an embodiment may be contained on a different data processing system readable storage medium. Alternatively, the instructions may be stored as software code elements on a DASD array, magnetic tape, conventional hard disk drive, electronic read-only memory, optical storage device, CD ROM, a floppy diskette or other appropriate data processing system readable medium or storage device.

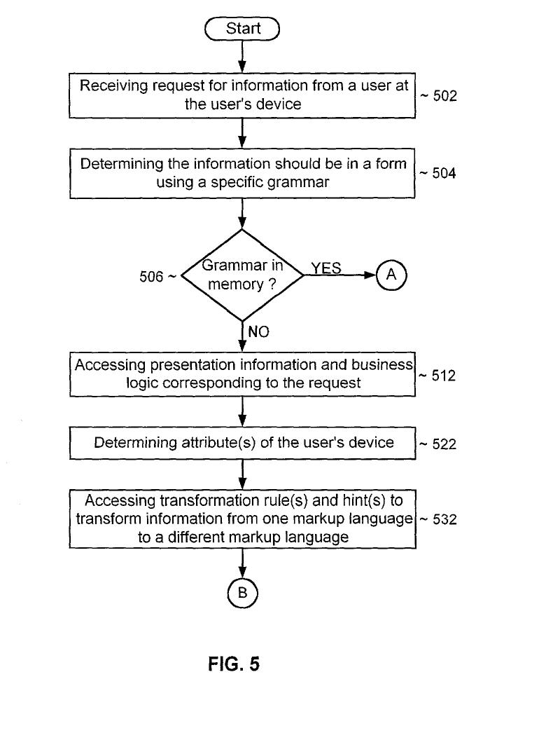

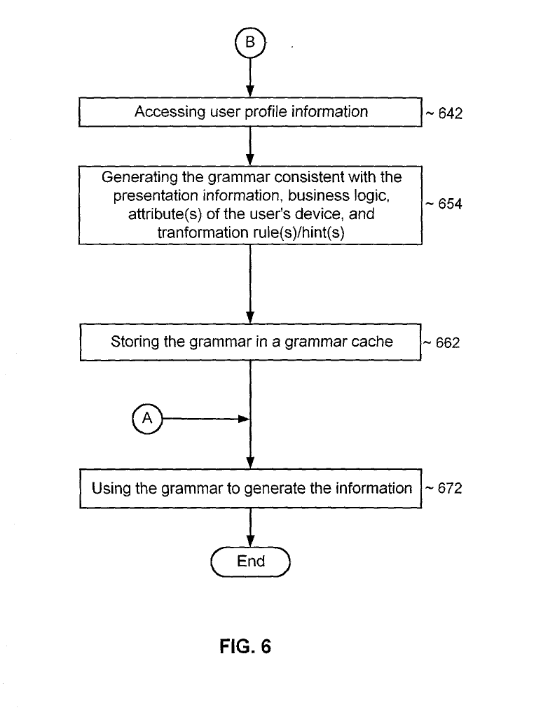

In an illustrative embodiment of the invention, the computer-executable instructions may be lines of compiled C⁺⁺, Java, or other computer programming language code. Other architectures may be used. Note that some or all of the components seen in the server computer 180, page generator 220, application server 240, or object manager 260 may reside within the any of the devices 142, 144, 146, or 148. Some or all of the functions of the server computer 180, page generator 220, application server 240, or object manager 260 may be incorporated into any or all of the devices 142, 144, 146, and 148, and vice versa. FIG. 4 includes an illustration of a software configuration for a software program that may be used with the system 100 in FIG. 1 or with the alternative server system in FIG. 2. FIGS. 5 and 6 include illustrations, in the form of a flow diagram, of the acts that can be performed by such a software program.

Communications between the devices 142, 144, 146, or 148 and the server computer 180, page generator 220, application server 240, or object manager 260 can be accomplished using radio frequency, electronic, or optical signals. When a user 120 is at the devices 142, 144, 146, or 148, the device may convert the signals to a human understandable form when sending a communication to the user 120 and may convert input from the user 120 to appropriate signals to be used by the devices 142, 144, 146, or 148, the server computer 180, the page generator 220, application server 240, or object manager 260.

Attention is now directed to an information handling system that can be used in accordance with embodiments of the present invention. FIG. 4 includes a software configuration 400 that can be used with the system. The configuration 400 can be used in transforming a specific type of extensible Markup Language (“XML”) called Application Description Markup Language (“ADML”) to other markup languages, including HyperText Markup Language (“HTML”) including all of its different versions, Wireless Markup Language (“WML”), Handheld Device Markup Language (“HDML”), VoiceXML, and the like. ADML can be an XML-based resource that describes the presentation of an application in a device and network (platform) agnostic manner.

The configuration 400 can include seven distinct Java and XML software components that leverage existing standards in their design and implementation as shown in FIG. 4. Those software components can include a document profile component 410, a device profile component 420, a transformation rule component 430, a user profile component 440, a mobile presentation engine (presentation component) 450, a Target Active Grammar (TAG) cache 462 and TAG file(s) 464, and a servlet engine (an execution environment or component) 470. Each of the components is described below in more detail.

Although the software configuration 400 and much of the following discussion regarding methods of using the system refer to server computer 180, the alternative system shown and described in FIG. 2 could be used. For example, the components within the configuration 400 may be executed by the page generator 220. The device profile and transformation rules may be obtained from database 270 using the object manager 260. Business (back-end) logic, class definitions, and business data may reside in HD 248 of the application server 240 or database 250. Other organizations and divisions of components and information are possible. Therefore, the organizations and divisions are given as examples and not meant to limit the present invention.

The document profile component 410 can include an editor 412 and an ADML file 414, which may be a resource file. The editor 412 can be used manually with standard text or can be used in an automatic mode using software, such as AGEA MobileSDK™ from AGEA Corporation of Austin, Tex.

ADML can be used as a language to describe an application in terms of presentation/user interfaces and business integration objects using integration classes in a device and network independent way. ADML can be defined in a document type definition (“DTD”) based on XML, similar to HTML is defined by a different DTD and is also based on XML. ADML includes a super-set grammar that reduces lines of code needed to be produced. This can be achieved by creating a union of the different markup languages so that potentially any or all markup languages may be used when sending information from the server computer 180 to the user 120.

ADML can be tailored for mobile or wireless devices, such as devices 142, 144, 146, or 148 as shown in FIG. 1. These devices can vary greatly in how they present information to user 120. ADML can borrow from screen-based Java 2 Platform, Micro Edition (“J2ME”)™ (of Sun Microsystems, Inc. of Palo Alto, Calif.) Mobile Information Device Profile (MIDP) user-interface rationale. The component 410 provides device and network independence and allows for the creation of mobile applications that leverage the unique characteristics of the device and network using various techniques including adaptive transformations.

The component 410 follows a model-view-controller paradigm for the separation of presentation (the visual, user interface presented to the user 120) and business logic (legacy software programs or rules currently in used in the enterprise; also referred to as back-end logic) by defining the interaction between the interface components and underlying problem-domain integration class(es).

ADML can support the notion of business integration objects for integration to allow access to existing back-end business logic and data sources via an integration class. ADML can be used to express information in terms of presentation information and integration classes. Within the ADML file, the classes can be declared and invoked. The definition of the class may reside within code in a different file. In the hardware configuration in FIG. 2, the class definition may reside within code in a file on HD 248 of the application server 240. The definition is typically expressed in terms of a computer programming language, such as Java, C⁺⁺, or the like, but not in terms of a markup language.

Locations for the different files may be found in a variety of different locations. Referring to FIG. 2, the ADML file may reside within database 230. The document type definition may be found in database 270, and the class definitions and other back-end logic may be found within database 250. Alternatively, the files may reside in HD 228, 248, or 268. The files can reside on a single data processing system readable medium, such as HD 188 with in FIG. 1. Note that the HD 188, 228, 248, 268, and database is 190, 230, 250, and 270 are examples of persistent memory. As will be explained in more detail later, the ability to use only presentation information and classes is beneficial to operators of network sites (private or public (internet)) that communicate to mobile communicating devices that use only specific markup languages.

Referring to Appendix I, with ADML, a <CLASS> tag can be used to declare the class, and a <DYNAMIC> tag can make a call to the class that is defined external to the ADML code file (not part of the ADML file). The DTD for ADML defines how the tags are to be interpreted by the application. A portion of the DTD for ADML appears in Appendix II. The <CLASS> and <DYNAMIC> tags are examples of specialized tags. After reading this specification, skilled artisans can appreciate that other specialized tags may be created to perform substantially the same function. The classes are used to perform functions and provide data, usually from a source outside the ADML file, for use with the presentation information. The component 410 can be used to provide tags with support for adaptive transformation and provide native support for Java Logic Blocks, which are blocks of Java software programming (computer programming language) code external to the ADML code. The component 41 0 can use message catalogs in support of multilanguage.

In Appendix I, the boldfaced text represents the business (back-end) logic, which in this case is in the form of an integration class. The regular (not boldfaced) text represents the structure of presentation information. The first three boldfaced lines (<CLASS name“listBean”. . . DummyListBean”/>) declares the class “listBean.” The boldfaced lines near the middle of the code (DYNAMIC_LIST . . . “choice”/I>) invokes the class “listBean” and passes information to the class for processing. In this specific example, all the code within the ADML file only includes presentation information and classes (declarations and invocations). The definition of the class “listbean” is part of code in a different file.

To the inventors' knowledge, object oriented concepts, such as the use of classes, have not previously been used with markup language code. In this manner, a computer programmer knowledgeable in Java, C, C⁺⁺, or the like may independently maintain the code for the class, while a different person knowledgeable in markup languages (but not necessarily knowledgeable regarding the details of the computer programming code for the class definition) only needs to know the interfaces with the class. After reading this specification, skilled artisans appreciate that code generation in ADML should be faster than conventional methods where many lines of Java, C, C⁺⁺, or the like are embedded within the markup language code (in other words, no invoking of classes that are inside or outside the markup language code). Also, as little as one ADML file can be used for all mobile communicating device-markup language combinations.

The device profile component 420 can be responsible for determining attributes of the connecting devices including type of device (cellular phone, pager, etc.), maker (e.g., Nokia, Ericsson, Samsung, etc.), model number, or the like. The device profile component 420 can generate device profiles 424 via the device profile manager 422, where the device profile 424 can describe attributes of the connecting device.

When a device 142, 144, 146, or 148 connects with the server computer 180, some of the attributes of the connecting device may be detected in the HyperText Transfer Protocol (“HTTP”) stream that reaches the server computer 180. The device profiles 424 can be used to supplement the information in the HTTP stream. A device profile 424 may contain the device characteristics and capabilities, including screen size, browser version, J2ME™ information, memory constraints, network characteristics, etc. Device profiles 424 may be defined in XML or may adhere to the World Wide Web Consortium's (W3C's) Composite Capabilities/Preference Profiles.

The device profile manager 422 within the device profile component 420 determines whether the appropriate device profile 424 for the corresponding device resides in a device profile cache (not shown) accessible by the device profile manager 422. The device profile cache, which is a type of temporary memory, helps improve the computing performance related to accessing device information because accessing the device profile 424 from the device knowledge database 426 uses more resources and takes significantly longer than accessing it from the cache.

Information for the device profiles can be obtained and loaded into the device knowledge database 426 manually. Alternatively, the device knowledge database 426 may be updated automatically by connecting server 180 to the site of a device manufacturer and downloading the appropriate device characteristics. Alternatively, the operator of the server computer 180 may subscribe to a service that can provide updates to the device knowledge database 426. Device profiles for new devices can be downloaded from a floppy diskette, CD ROM, or the like, or may be downloaded over a network, such as the internet. The downloading may be performed on a periodic basis or on an “as-needed” basis (device profile accessed when needed by the mobile presentation engine 450 and not found in the device knowledge database 426). The device knowledge database 426 may be part of the database 190 as shown in FIG. 1 or database 470 in FIG. 2. The device profile manager 422 can also provide a user interface for the administration of the device knowledge database 426 and the transformation hints for device families.

Transformation hints can be defined by the device and device family information and describe the typical attributes for that device or device family. Transformation hints can include characteristics that describe families of devices. Supported device families may include “Phone,” “PDA,” “2way-pager,” “Smartphone-Landscape,” or the like. These hints may be part of the device profile 424 and can be used by the mobile presentation engine 450 to dynamically adapt the content targeted for a given device. For example, a four-column table may be adjusted to a two-column table that is twice as long for display on a phone. On a PDA, the same table may keep its original structure because all the four columns can be displayed. Transformation hints can be used in the absence of an explicit ADML overlay.

The transformation hints are not required, but generally make the presentation of the information more aesthetically pleasing to the user. The transformation hints may persist in the device knowledge database 426 and be part of the device profile 424. Alternatively, the hints may persist in the repository 434 of the transformation rule component 430.

The transformation rule component 430 can be used to select appropriate transformation rule(s) 422 for the markup language used by device 142, 144, 146, or 148. Transformation rules 432 can describe the acts used to transform ADML to other markup languages, such as HTML (and its various versions), HDML, WML, and the like. Transformation rule(s) may be based on the W3C”s extensible Stylesheet Language (“XSL”) and XSL Transformations specifications. At least one transformation rule 432 may be sent to the mobile presentation engine 450. In addition, the architecture permits extensibility by allowing developers to add their own transformation rules, if desired. Similar to the device profiles, a subscription service may be used by the operator of the server computer 180 or computers in FIG. 2 to keep current on the transformation rules between markup languages, particularly as new markup languages are created. The transformation rules can persist in the repository 434.

The adaptive transformations can be used in the absence of an explicit ADML overlay. The transformation hints and rule can be transparent to web developers, ensuring low maintenance and low cost of development and ownership. The appropriate transformation hints and rules are selected and applied based on device characteristics and markup language used by the specific device.

A user profile component 440 can be used to describe the user information, including preferences, security information, and the like. A user profile may be represented in an XML grammar.

The mobile presentation engine 450 can provide the TAG file or files (hereinafter “TAG file”) 464 to the servlet engine 470. TAG file 464 may include Java Server Pages (JSP) that can include embedded Java logic (software programming code) generated using the ADML file 414, integration objects, and target markup language (e.g., WML, HTML, HDML, etc.) to address devices that use the target markup language.

The mobile presentation engine 450 may determine if a target active grammar (“TAG”) corresponds to a TAG file 464 within the TAG cache 462 or if the TAG should be generated. If the TAG file for the user's device 1 42, 144, 146, or 1 48 resides in the TAG cache 462, the mobile presentation engine 450 accesses the TAG file 464 from the TAG cache 462 and sends the TAG file 464 to the servlet engine (execution environment or component) 470. The TAG cache 462 helps to reduce the number of transformations performed, thus resulting in significantly improved performance of the configuration 400.

If the TAG file 464 does not reside in the TAG cache 462, the mobile presentation engine 450 can generate the TAG file 462 from the ADML file 414, the device profile 424, a transformation rule 432, and optionally, a transformation hint and the user profile. The mobile presentation engine 450 can retrieve an ADML overlay to use, if any. The ADML overlays can be transparent to the developer. Overlays may replace sections (screens) of the generic/default ADML based on device characteristics. For example, a generic ADML file may be used with N different screen presentations that can be sent by the server computer 180, where N is a finite whole number. Overlays may be applied to specific sections of the generic ADML.

Assume that the device profile 424 indicates that the user's device can only use the first and third screen presentations of the N presentations. The mobile presentation engine 450 would generate a TAG adapted to the first or third screen presentation. The overlays can provide a user interface representation for a given section of the application based on characteristics of the device 142, 144, 146, or 148 requesting the application. After generating the TAG, a copy of the TAG can be stored as a new TAG file 464 in the TAG cache 462 for the same or subsequent user requesting the same information using the same type of device. The TAG file 464 can be sent to the servlet engine 470 after generation.

The servlet engine 470 can function as a JSP execution environment. The servlet engine 470 can execute the TAG, invoke business logic using the integration classes (via a <CLASS> and <DYNAMIC> tags) for back-end data and access to applications that are external to the ADML code (file). In other words, when the TAG is executed, the server computer 180 can access back-end logic and resources.

The function of the various software components in FIG. 4 is better understood with an example that illustrate a method of using the software components (as shown in FIGS. 5 and 6). Unless stated otherwise, the method is discussed from a perspective of the server computer 180 sending and receiving signals.

The user 120 at any one of the devices 142, 144, 146, or 148 may send and the server computer 180 may receive a request for information (block 502 in FIG. 5). The mobile presentation engine 450 determines if the information should be in a form using a specific grammar (block 504) for a specific markup language and connecting device. The information for the specific grammar can be within an already existing TAG file 464 in the TAG cache 462. In order to avoid unnecessary generation of the TAG file 464, the method determines whether the grammar resides in memory (block 506). The mobile presentation engine 450 can perform this by accessing the TAG cache 462 to determine if it has the appropriate TAG file 464.

If the TAG file 464 is found in the TAG cache 462, the method proceeds along the “yes” branch from decision diamond 506. The TAG file 464 is passed to the servlet engine 470. The method can use the grammar to generate the information (block 672 in FIG. 6). In other words, the servlet engine 470 can use the TAG file 464 in generating a page for the user 120 that can be displayed on a screen of device 142, 144, 146, or 148, depending on the connecting device used.

If the TAG file 464 is not in the TAG cache 462, the method proceeds along the “no” branch from decision diamond 506 in FIG. 5. The method can access presentation information and business logic corresponding to the request as shown in block 512. In one example, the ADML file including the presentation information and business logic is accessed by the mobile presentation engine 450. The method can also determine attribute(s) of the user's device as shown in block 522. The attribute(s) of the user's device may come from the HTTP stream that includes the user's request and is received by the server computer 180. A device profile 424 corresponding to the user's device can be sent to the mobile presentation engine 450.

The method continues with accessing transformation rule(s) 432 and hint(s) to transform information from one markup language to a different markup language (block 532) that is compatible with the user's device. The transformation hint(s) may be part of the device profile 424. The transformation rule(s) 432 may be retrieved from repository 434. The transformation rule(s) 432 and optional transformation hint(s) are received by the mobile presentation engine 450.

Optionally, the method can access user profile information as shown in block 642 in FIG. 6. The user profile can be sent from the user profile component 440 and can be received by the mobile presentation engine 450.

The method can then generate the grammar consistent with the presentation information, the business logic, attribute(s) of the user's device, and transformation rule(s)/hint(s) as shown in block 654. In one embodiment, the mobile presentation engine 450 can use the ADML file 414 (having presentation information and business logic), the device profile 424 that corresponds to the attribute(s) of the user's device, and transformation rule(s) 432 and optional transformation hint(s) and use profile to generate the TAG file 464. Because the TAG file 464 may be used by the same user or a subsequent user with the same type of connecting device, the TAG file 464 can be stored in the TAG cache 462. Therefore, the method performs an optional act of storing the grammar in the grammar cache as shown in block 662.

The method can use the grammar to generate the information as shown in block 672. The activity recited in block 672 was previously described with respect to the “yes” branch coming from decision diamond 506 in FIG. 5.

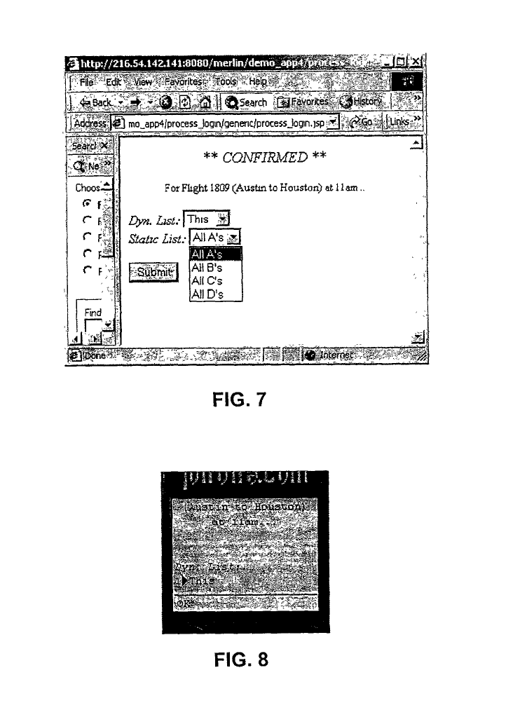

FIGS. 7 and 8 show exemplary displays using the ADML code in Appendix I. FIG. 7 includes a view that may be seen using the laptop computer 144 as the connecting device. FIG. 8 includes a view that may be seen using cellular phone 148 as the connecting device. The laptop computer 144 may use a mouse to activate the pull-down menus and a submit button. The cellular phone 148 may use a thumb wheel instead of a mouse. Note the differences in size and display of information in FIGS. 7 and 8.

When the server computer 180 with the software configuration 400 is used for the first time, the TAG cache 462 should be empty. Examples below show how the system 100 can be used with different users. A first user 120 may be using a cellular phone 148 to send a first request for information to the server computer 180. During this first use, the TAG file 464 will be generated because the cache is empty. After generating the TAG file 464 for the specific device 148, the TAG file 464 is stored in the TAG cache 462.

A second user (not shown) sends and the server computer 180 receives a second request for the same information. In this example, the second user and the first user are using the same type of connecting device. In other words, the first and second users have cellular phones that are made by the same company and have the same model number. The method can determine that the TAG that was generated for the first user's device can be used for the second user's device. In this instance, the TAG file 464 needed for the second user lies within the TAG cache 462. Therefore, the TAG file 464 can be used for the second device and is accessed from the TAG cache 462. The TAG file 464 is not regenerated. The use of the TAG cache 462 saves valuable computer resources and allows faster generation of the page to be sent to the second user. The method can further include sending the information using TAG file 464 to the second user.

A third user (not shown) sends and the server computer 180 receives a third request for the same information as requested by the first and second users. Unlike the first and second users, the third user may be using a pager, such as pager 146 shown in FIG. 1. The TAG file for the cellular phone 148 may not work very well for the pager 146. The TAG cache 462 may not have a TAG file corresponding to the pager 146. Therefore, a TAG file can be generated using acts 512, 522, 532, 642, 654 as previously described. The TAG file can be saved to the TAG cache 462 for another user that may be connecting using a pager similar to pager 146. The servlet engine 470 can generate the information that is sent to pager 146.

The mobile presentation system has many advantages over conventional systems, some of which have already been described. The JSP technology offers a Java-based way to create dynamic Web or other network applications that are both platform-independent and server-independent. JSP technology can allow for the complete separation of presentation and business logic, but can still invoke the integration class(es) to provide an integration. with back-end business logic and data. Although much of the discussion herein has involved JSP, Active Server Pages (ASP) may be used in an alternative embodiment.

The mobile presentation system can be used to provide information to a user in a more user-friendly manner. Conventionally, information may be provided in a static form, that is, each set of information is chosen with a specific language and presentation device in mind. In order to allow the information to be displayed in a format tailored for the different devices, the information needs to be put in many different language and device combinations.

Unlike conventional practice, the mobile presentation system can use the same information but adapt it for a specific markup language and device dynamically. This may allow web developers to generate more web pages on their own without the need to have a Java programmer modifier his or her code for the different languages and devices. This can reduce the cost of ownership of a website or other network site, particularly those tailored for mobile devices. The ADML file can achieve this because it describes the information by defining presentation information and business logic.

The mobile presentation system is flexible. As new markup languages and devices are used, the corresponding device profiles 424, transformation hint(s) and transformation rule(s) 432 can be added to the device knowledge database 426 and repository 434.

The mobile presentation system is particularly advantageous to thin-client applications. Thin-client generally refers to a device that has no significant way to transform data received from server 180 to a more readable format. Because most of the transformation can be performed on the server side, thin clients may not be neglected with respect to receiving information tailored more closely to the specific characteristics of their devices.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

[image]

[image]

[image]

[image]

[image]

[image]

[image]

[image]

[image]

[image]

[image]

[image]

1. A method of generating an information for a first user comprising:
receiving a first request for the information from the first user, wherein the first request came from a first device of the first user;
accessing a presentation information and a business logic corresponding to the first request;
determining an attribute of the first device;
accessing a first transformation rule that can be used to transform the presentation information and the business logic in a first markup language to a second markup language compatible with the first device; and
generating a first grammar consistent with the presentation information, the business logic, the attribute of the first device, and the first transformation rule; and
using the first grammar to generate the information.

2. The method of claim 1, further comprising:
receiving a second request for the information from a second user, wherein the second request came from a second device of the second user;
determining that the first grammar can be used for the second device; accessing the first grammar from memory; and
sending the information using the first grammar to the second user.

3. A method of claim 1, further comprising:
receiving a second request for the information from a second user, wherein the second request came from a second device of the second user;
determining an attribute of the second device, wherein the attribute of the second device is different from the attribute of the first device;
accessing a second transformation rule that can be used to transform the presentation information and the business logic in a first markup language to a third markup language compatible with the second device; and
generating a second grammar consistent with the presentation information, the business logic, the attribute of the second device, and the second transformation rule.

4. The method of claim 1, wherein the first device is received at least in part using a wireless communicating medium.

5. The method of claim 1, wherein the business logic includes software programming code in a computer programming language.

6. The method of claim 1, further comprising accessing a first user information, wherein the first user information includes a preference or a security information.

7. The method of claim 1, further comprising accessing a first transformation hint that can be used to transform the presentation information and the business logic in the first markup language to the second markup language, wherein the first transformation hint is not required for generating the first grammar.

8. The method of claim 1, wherein the first markup language is XML and the second markup language is selected from a group consisting of WML, HTML, and HDML.

9. A method of generating an information for a first user comprising:
receiving a first request for the information from the first user, wherein the first request came from a first device of the first user;
determining that the information should be in a first form using a first grammar; and
determining that the first grammar resides in memory, wherein the first grammar is consistent with a presentation information, a business logic, an attribute of the first device, and a transformation rule, wherein:
the presentation information and the business logic correspond to the first request; and
the first transformation rule can be used to transform the presentation information and business logic in a first markup language to a second markup language compatible with the device; and
using the first grammar in generating the information.

10. The method of claim 9, further comprising:
receiving a second request for the information from a second user, wherein the request came from a second device of the second user; and
determining that the information should be in a second form using a second grammar; and
determining that the second grammar does not resides in memory;
determining an attribute of the second device, wherein the attribute of the second device is different from the attribute of the first device;
accessing a second transformation rule that can be used to transform the presentation information and the business logic in a first markup language to a third markup language compatible with the second device;
generating a second grammar consistent with the presentation information, the business logic, the attribute of the second device, and the second transformation rule; and
storing the second grammar in memory.

11. The method of claim 9, wherein the first device is received at least in part using a wireless communicating medium.

12. The method of claim 9, wherein the business logic includes software programming code in a computer programming language.

13. The method of claim 9, further comprising accessing a first user information, wherein the first user information includes a preference or a security information.

14. The method of claim 9, further comprising accessing a first transformation hint that can be used to transform the presentation information and business logic in the first markup language to the second markup language, wherein the first transformation hint is not required for generating the first grammar.

15. The method of claim 9, wherein the first markup language is XML and the second markup language is selected from a group consisting of WML, HTML, and HDML.

16. An information handling system for generating an information in response to a first request from a first user, the system comprising:
a document profile component that is capable of providing a presentation information and a business logic corresponding to the first request;
a device profile component that is capable of providing an attribute of a first device of the first user;
a transformation rule component capable of providing a first transformation rule that can be used to transform the presentation information and the business logic in a first markup language to a second markup language compatible with the first device; and
a presentation component capable of generating a first grammar consistent with the presentation information and the business logic, the attribute of the first device, and the first transformation rule.

17. The information handling system of claim 16, further comprising a grammar cache capable of storing the first grammar.

18. The information handling system of claim 16, further comprising a user profile component capable of providing a user preference or a security information.

19. The information handling system of claim 16, wherein the first device includes a wireless communicating medium.

20. The information handling system of claim 16, wherein the business logic includes software programming code in a computer programming language.

21. The information handling system of claim 16, wherein the transformation rule component further comprises accessing a first transformation hint that can be used to transform the presentation information and the business logic in the first markup language to the second markup language, wherein the first transformation hint is not required for generating the first grammar.

22. The information handling system of claim 16, wherein the first markup language is XML and the second markup language is selected from a group consisting of WML, HTML, and HDML.
